(19) United States
(12) Patent Application Publication
(10) Pub. No.: US 2008/0202586 A1
(43) Pub. Date: Aug. 28, 2008

(54) Automatic wireless liquid/water level controller

(76) Inventor: Radhakrishna Shesha Iyengar Togare, Vancouver, WA (US)

Correspondence Address: Radhakrishna Togare, X on Labs, 3500 SE 175th Avenue, Vancouver, WA, 98683, US

(21) Appl. No.: 12/070,729

(22) Filed: Feb. 19, 2008

Related U.S. Application Data
(60) Provisional application No. 60/902,716, filed on Feb. 21, 2007.

(51) Int. Cl. F17D 3/00

(52) U.S. Cl. 137/1

(57) ABSTRACT

The “Automatic, Wireless Liquid/Water Level Controller”, hereafter called “Automatic Wireless Liquid Level Controller” or “Automatic Wireless Water Level Controller” or “Automatic Wireless Water Controller”, works on the principle of wireless communication and control for monitoring and controlling the liquid level in one or more storage tanks (or similar storage units) and automatic pumping of liquid (such as water, etc.), for refilling such storage tank(s), when the liquid level in these storage tank(s) hits set lower threshold level.

### CROSS REFERENCE TO RELATED APPLICATION

This application claims the benefit of U.S. provisional patent application Ser. No. 60/902,716 filed Feb. 21, 20078.

### FIELD OF THE INVENTION

The “Automatic, Wireless Liquid/Water Level Controller”, hereafter called “Automatic Wireless Liquid Level Controller” or “Automatic Wireless Water Level Controller” or “Automatic Wireless Water Controller”, works on the principle of wireless communication and control for monitoring and controlling the liquid level in one or more storage tanks (or similar storage units) and automatic pumping of liquid (such as water, etc.), for refilling such storage tank(s), when the liquid level in these storage tank(s) hits set lower threshold level.

### BACKGROUND OF THE INVENTION

Storing water in one or more storage tanks (or similar storage units) kept on top of buildings or at a convenient height is known for centuries. Such storage tanks are also called “overhead tanks”. Normally, the water to fill these storage tanks is obtained from a tube well, an underground storage tank (also called sump tank), or any natural reservoir. In all such cases, the storage tank is kept at a level that is higher than the highest water level of the water source used for filling the tank. The stored water is normally drawn from the overhead storage tank towards the gravity through one or more outlets 9, or output lines 9 routed in and around the buildings, terminated by faucets (also called taps), control valves, or similar means (not shown in figure) at desired places.

There are many types of pumping systems available to pump the water to replenish (refill) the overhead tank(s). Electric power operated motorized pumping is generally the preferred choice. An impeller operated by an electric motor lifts the water up to the required height. In the absence of the electric supply, water pumps driven by Internal Combustion engine, steam engine, solar power, storage battery, etc. can be used. Depending on the height of the overhead tank from the source of the water, submersible pump, vacuum pump, or jet pump is used. In case of vacuum pumps, the water is lifted due to continuous vacuum created by the rotating movement of impeller that causes the displacement of air. In case of submersible pumps, the pump is immersed in the water and the water is directly pushed up thereby lifting the water through the pipe to the desired height to fill the overhead tank(s).

With the increase in height of the buildings and deepening underground water column, efficient pumping of water by automatic means are being developed. Such automatic pumping systems use wired water level detection sensors for detecting the water level in over head storage unit (tank) and, optionally, underground storage reservoir to automatically control and operate the water pump to refill the overhead tank. Also, increase in height of the buildings or the distance between tank and motor power control panel calls for using very large length of multi-core cables (wires) from various sensors to the main power control panel. Added to all, the initial capital and subsequent maintenance costs for automatic pumps that use wired water level detection sensors are very high.

### BRIEF DESCRIPTION AND SUMMARY OF THE INVENTION

The invention of the “Automatic Wireless Liquid/Water Level Controller” or “Automatic Wireless Water Level Controller, shown in FIG. 1, generally relates to the wireless communication and control based automatic liquid (such as water, etc.) pumping systems to pump any type of liquid (or water) against the gravity from a lower level to a higher level and the improvements thereto.

The uniqueness of this invention comes from the fact that the operation of this automatic wireless pumping system uses many novel methods. It uses a novel method, hereafter called, “duel tank window sensing”, for the detection and generation of window control signals that are used for controlling the pumping operation to refill the overhead tank. In addition, it also uses a one or more “watch dogs” to ensure that the pumping operation is withheld during the non-availability of utility power or resumed after utility power is back to normal. Further, the method also uses device specific, secured wireless communication between various internal devices without causing any interference with outside devices or systems during transmission, reception and management of wireless data and signals generated during the operation of the invented device.

This method can complement or replace the existing pumping techniques that use manual operation or automatic pumping that uses wired water level detection sensors. Further, this method can also be used to pump water for a long distance with the use of long distance wireless data communication or one or more repeaters placed in between transmitters and main control station. The use of the “Automatic Wireless Water Level Controller” is limitless when the application area is considered.

### BRIEF DESCRIPTION OF THE DRAWINGS

FIG. 1 shows the basic configuration of Automatic Wireless Liquid/water Level Controller, also called Automatic Wireless Liquid Level Controller or Automatic Wireless Water Level Controller, identified by 50, that is used for pumping water from underground Storage Tank (source) to Over Head Storage Tank (destination unit).

FIG. 2 shows the basic configuration of Automatic Wireless Liquid/water Level Controller, also called Automatic Wireless' Liquid Level Controller or Automatic Wireless Water Level Controller, identified by 50, that is used for pumping water from a Tube Well (source) to Over Head Storage Tank (destination unit).

### DETAILED DESCRIPTION AND BEST MODE OF THE INVENTION

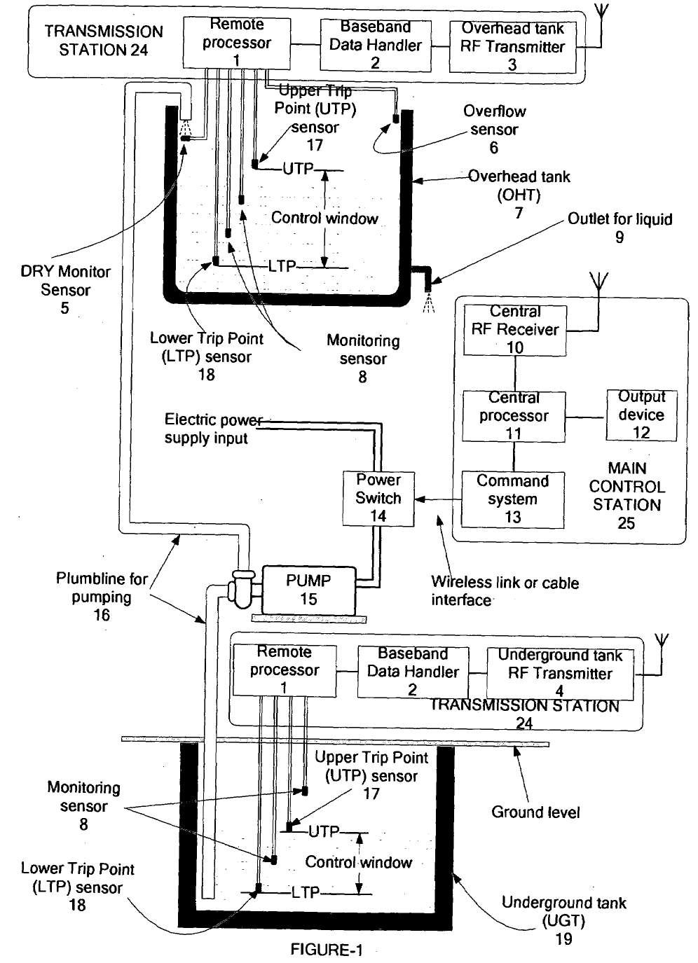

FIG. 1 shows the Automatic Wireless Water (liquid) Level controller, identified by 50, that is used for automatic pumping water or any other liquid, against the gravity, that uses novel method of duel window sensing. For clarity and ease of explanation, pumping of water from an underground storage tank (source) 19 to an overhead tank 7 is considered here. However, the source of water can be from a tube well, a well, an underground reservoir (sump), or any other means. Water pumped from a source 19 can be stored in an overhead tank 7 placed in a neighborhood or on the roof top of a building such that the tank 7 is kept at a level higher than that of the highest water level of the water source used to fill the overhead tank 7.

The automatic wireless water pumping consists of an underground tank (UGT) 19, an overhead tank (OHT) 7 and a pump 15. The pump lifts water against the gravity from UGT 19 to OHT 7 through the plumb line 16, when the pump 15 is ON. Both UGT 19 and OHT 7 have one or more monitoring sensors 8 located at various heights within the tank. The monitoring sensors 8 help in wireless telemetry monitoring of water level in there respective tanks (7, 19). In addition each tank (7, 19) is fitted with a pair of window detection sensors (17, 18), placed at two different heights inside the tank (7, 19). The window detection sensors (17, 18) are used to identify the upper and lower trip points (UTP and LTP). The UTP and LTP are required for generating window detection signals that are used by main control station for controlling the on/off operation of the pump 15 when the water level inside the tank (7, 19) crosses the set control window. One of the window detection sensors (17, 18) located inside the tank at a level that is higher than the other window detection sensor is called the Upper Trip Point sensor 17 or UTP sensor 17. The other window detection sensor is called the Lower Trip Point sensor 18 or LTP sensor 18. The placement of window detection sensors (17, 18) is arbitrary so long the UTP sensor 17 is located at a level higher than that of the LTP sensor 18 such that both sensors (17,18) together form a control window that is used to maintain the on/off operation of the pump 15 to maintain the water level within this set control window.

While monitoring sensors 8 placed inside the tank (17, 18) does the function of only monitoring the water level, the window detection sensors (17, 18) perform the function of both monitoring the water level as well as aiding the main station 25 in generating the window control commands that are used for controlling the on/off operation of the pump 15, when the water level inside their respective tank (7, 19) hits the extreme points of the set control window. Further, while the window detection signals from the OHT 7 window detection sensors (17, 18) requests for the generation and execution of window control commands for the on/off operation of the pump 15, the window detection signals from the UGT 19 window detection sensors (17, 18) authorizes the final execution of the window control commands, by the main control station 25, requested by the OHT 7 window detection sensors (17, 18).

To enable the wireless transmission of telemetry monitoring data and window detection signals from sensors (5, 6, 8, 17, 18) located inside the tanks 7 and sensors (6,8,17,18) located inside tank 19, each tank (7,19) is fitted with a wireless transmission system 24. Each transmission system 24 consists of a remote signal processor 1, base-band data handler (BDH) 2 and a RF transmitter 3. The outputs coming from all sensors (5, 6, 8, 17, 18) of a particular tank (7, 19) that are controlled by on or more watch dogs (located inside the remote processor 1, now shown in figure) are processed by the remote processor 1, formatted by the BDH 2 and wrapped with sensors (5, 6, 8, 17, 18) identifier code. The combined signal is then passed via the RF transmitter 3 to the main control station 25.

The main control station 25 consists of a central RF receiver 10 for receiving the telemetry monitoring data and window detection signals sent from transmitters (3, 4), a central processor 11 for un-wrapping the received signals (consisting of sensors (5, 6, 8, 17, 18) identifier code), an output device 12 for displaying the telemetry status of various sensors (5,6,8,17,18) and a command system 13 for generating and executing the window control commands to control the power supplied to the pump 15 thereby controlling the pump's 15 on/off operation.

### BEST MODE OF OPERATION

In the steady state condition, the water in the overhead tank 7 (OHT 7) remains within the set window of the window detection sensors (17, 18) keeping the pump 15 in OFF condition. However, when the water in the OHT 7 goes below the lower trip point (LTP) of the control window (while the water is being drawn out of tank), the OHT 7 LTP sensor 18 generates the LTP window detection signal. The processed window detection signal along with LTP sensor 18 identifier code is then wirelessly routed to the main control station 25 requesting it to turn ON the pump 15 to refill the OHT 7.

The main control station processes the OHT 7 LTP window detection signal and sensor 18 identifier code that it received from the OHT transmitter 3 and compares it with the most recent LTP/UTP window detection signal that it received from the UGT 19 transmitter 4. If the water in the UGT 19 is above the LTP level, the UGT 19 LTP detection signal keeps the main logic gate (located inside the command system 13) open for the OHT 7 LTP detection signal to pass through the logic gate. Under this condition, the central processor 11 generates and executes the pump 15 ON command as requested by the OHT 7 LTP sensor 18 by turning ON the power supply to the pump 15.

The pump 15 starts pumping the water to the OHT 7 while the central processor 11 constantly monitors for any change in LTP signal status that may come from UGT 19 LTP sensor 18. In the absence of any change in signal status from the UGT 19 LTP sensor 18, the pump 15 stays ON until the water in the OHT 7 reaches UTP level at which point the UTP detection signal received from the OHT 7 UTP sensor 17 causes the central processor 11 to generate and execute the pump 15 OFF command. However, while pumping the water to OHT 7, if the central processor 11 receives change in signal status from the UGT 19 LTP sensor 18 indicating that the UGT 19 is getting dried out and that there is no enough water to fill the OHT 7, the central processor 11 initiates and generates the pump 15 HOLD command keeping the pump 15 in HOLD condition irrespective of the water level in the OHT 7. The pump 15 remains in the HOLD condition indefinitely until the central processor 11 receives the UTP signal from the UGT 19 UTP sensor 17 indicating that there is enough water available in UGT 19 for pumping.

When the central processor 11 receives the UTP signal from the UGT 19 UTP sensor 17, the central processor 11 releases the HOLD on the pump 15 allowing the pump 15 to continue pumping of the water while the central processor 11 constantly monitors for any change in UGT 19 LTP signal status to repeat the HOLD cycle mentioned above. In the absence of any change in signal status from the UGT 19 LTP sensor 18, the pump 15 stays ON until the water in the OHT 7 reaches UTP level at which point the UTP detection signal received from the OHT 7 UTP sensor 17 causes the central processor 11 to generate and execute the pump 15 OFF command.

In order to ensure that the water actually flows through the plumb line 16 connected between UGT 19 and OHT 7 during pumping, a DRY monitor sensor 5 is located along the pumping water path to detect the flow of water. The problem of water not getting pumped even after the pump 15 is kept ON can be due to a faulty pump 15 or leaky foot valve (or non-return valve, used in primed pumps) or for many other reasons. Under this condition, the DRY monitor sensor 5 sends “no water detected” signal within a specific duration after turning ON the pump 15. This causes the central processor 11 to generate and execute the pump 15 OFF command to turn OFF the power supply to the pump 15 indicating that the problem of water not reaching the OHT 7 is beyond the domain that the central processor 11 can manage. This is also indicated by an audio alarm and/or a visual display on output device 12 panel (also called, main control panel 12) of the main control station 25 for further analysis and corrective action by the user.

Further, the OHT 7 is optionally fitted with an overflow sensor 6 for generating OHT 7 overflow signal to send a second request to the central processor 11 to turn OFF the pump 15 in case of overflow. This second request results from the failure of the first request sent by the OHT 7 UTP sensor 17 to turn the pump 15 OFF. Since the failure of first request can result in continued pumping of water and possible overflow from OHT 7, the second request provides an added protection in avoiding the tank 7 overflow by re-trying to turn the pump 15 OFF. In addition to generating a second request to turn the pump 15 OFF, the overflow signal also helps in generating audio/visual alarm at the main control station 25 to indicate the failure of the command requested by OHT 7 UTP sensor 17 to turn the pump 15 OFF.

It may so happen that the power supply to the pump 15 that is coming from the utility power line may not be available while the tanks generate window detection signals for on/off operation of the pump 15. When this happens, the control commands cannot turn on/off the pump 15 even when the command system receives proper window detection signals. To take care of such power failures, transmission systems 24 and main control station 25 are fitted with one or more watch dogs. Watch dogs constantly monitor the operation of the pump 15 and keep the pump 15 indefinitely in HOLD condition when the power supply fails during pumping operation and resumes normal on/off operation of the pump 15 (depending on the previous status of window detection signals) when the power supply that operates the pump resumes.

Manual bypass operation: To ensure the operation of the pump 15 to fill the water during emergencies, the system incorporates manual bypass options to turn on/off the pump. This bypass command is generated by operating a wireless keefob remote control (not shown) or a manual switch located at a convenient location.

### DRAWINGS

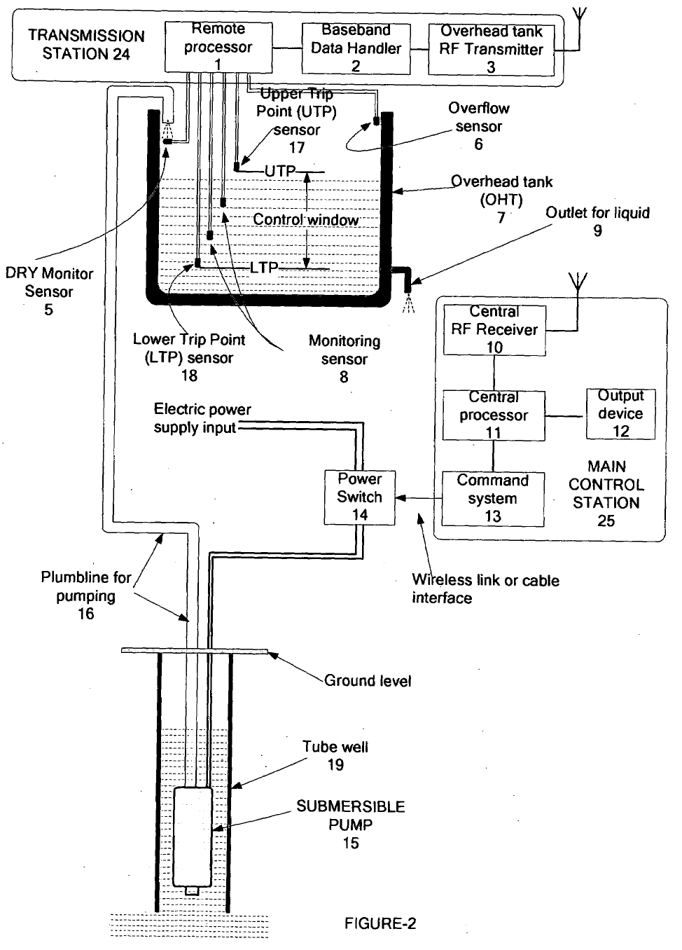

FIG. 1-2 attached.

What is claimed is:

1. An Automatic, Wireless liquid level control method that works on the principle of wireless communication, wherein said method is used to wirelessly monitor and control liquid level in a liquid storage unit (also called destination liquid storage unit, destination storage unit, or destination storage tank) or similar means by automatically pumping said liquid from a liquid source (such as tube-well, a well, a storage unit, or similar means) to a said destination storage unit (such as a storage tank, an underground reservoir, an over head tank, a roof top storage unit, or similar means used for storing said liquid), wherein said destination storage unit is normally kept at a level higher than that of said liquid source, wherein said liquid from said liquid source is pumped against the gravity for replenishing (refilling) said destination storage unit when said liquid level in said destination storage unit hits the lower threshold point when said liquid is drawn from said destination storage unit, comprising:
a pair of liquid level detection sensors or similar means placed arbitrarily at two different heights inside each liquid storage unit forming a control window (to always maintain liquid within said control window), wherein said liquid level detection sensors generate window detection signals when said liquid level inside said storage unit goes above or below the sense (trip) points of said liquid level detection sensors, wherein said window detection signals along with sensors identifier code are wirelessly sent to main control station for generation of window control commands, wherein said window control commands are used for on/off operation of a pump to automatically replenish (refill) said destination storage unit.
one or more optional monitoring sensors kept at various levels within said liquid storage unit for monitoring said liquid level status and generating telemetry monitoring signals (data), wherein said telemetry monitoring signals along with said sensors identifier code are wirelessly sent by wireless transmission system to said control station, wherein said control station processes said telemetry monitoring data received and generates visual display and/or audio alarm, corresponding to said telemetry monitoring data, at said main control station.
at least one said wireless transmission system for each said liquid storage unit (optional for tube well, bore well or common well), wherein said wireless transmission system processes said window detection signals and said telemetry monitoring signals (data), wherein said wireless transmission system transmits processed signals along with said sensors identifier code to said main control station (main wireless reception system).
one said main wireless reception system, wherein said wireless reception system receives said window detection signals and said telemetry monitoring signals (data) along with said sensors identifier code sent from one or more said wireless transmission systems, wherein said wireless reception system processes said window detection signals, said telemetry monitoring data, and said sensors identifier code received, and generates said window control commands to control the flow of said liquid from said liquid source to said liquid destination unit, wherein said telemetry monitoring data is optionally used to generate said visual display and/or audio alarm on status of said liquid present in various said storage units.
an optional wireless communication link between said pump's on/off logic circuitry (having a wireless receiver module) and a stationary or handheld wireless transmitter unit for automatic or manual on/off control operation of said pump used to replenish (refill) said destination storage unit.

2. An Automatic, Wireless liquid level control method that works on the principle of wireless communication, wherein said method is used to wirelessly monitor and control liquid level in a liquid storage unit (also called destination liquid storage unit, destination storage unit, or destination storage tank) or similar means by automatically pumping said liquid from a liquid source (such as tube-well, a well, a storage unit, or similar means) to a said destination storage unit (such as a storage tank, an underground reservoir, an over head tank, a roof top storage unit, or similar means used for storing said liquid), wherein said destination storage unit is normally kept at a level higher than that of said liquid source, wherein said liquid from said liquid source is pumped against the gravity for replenishing (refilling) said destination storage unit when said liquid level in said destination storage unit hits the lower threshold point when said liquid is drawn from said destination storage unit, comprising:
“duel tank window sensing” method that involves on/off operation of said pump (to refill said destination storage unit) based on the logical comparison of said window detection sensor statuses of both said liquid storage source and said destination liquid storage units, wherein said window detection sensors of said destination liquid storage unit requests for the generation of window control commands for the on/off operation of said pump, said window detection sensors located inside said liquid storage source authorizes the final execution of said window control commands (by said main control station) requested by said window detection sensors of said destination liquid storage unit.

3. An Automatic, Wireless liquid level control method that works on the principle of wireless communication, wherein said method is used to wirelessly monitor and control liquid level in a liquid storage unit (also called destination liquid storage unit, destination storage unit, or destination storage tank) or similar means by automatically pumping said liquid from a liquid source (such as tube-well, a well, a storage unit, or similar means) to a said destination storage unit (such as a storage tank, an underground reservoir, an over head tank, a roof top storage unit, or similar means used for storing said liquid), wherein said destination storage unit is normally kept at a level higher than that of said liquid source, wherein said liquid from said liquid source is pumped against the gravity for replenishing (refilling) said destination storage unit when said liquid level in said destination storage unit hits the lower threshold point when said liquid is drawn from said destination storage unit, comprising:
a method of generating “no liquid detected” signal, wherein a DRY monitor sensor located along the pumping liquid path is used to detect the flow of liquid while the liquid is being pumped, wherein any problem of liquid not reaching said destination storage unit (tank) even after the pump is kept ON for a specific duration generates “no liquid detected” signal, wherein said “no liquid detected” signal prompts said main control station to turn said pump OFF, wherein said “no water detected” signal is also used to generate said visual display and/or audio alarm prompting the user for further analysis of the problem of said liquid not reaching said destination storage tank.
